(19) United States
(12) Patent Application Publication
(10) Pub. No.: US 2003/0067139 A1
(43) Pub. Date: Apr. 10, 2003

(54) Anti-jackknife safety system

(76) Inventor: Jimmy D. Hosmer, Scottsboro, AL (US)

Correspondence Address: Joseph H. Beumer, Suite 1602 D, 555 Sparkman Drive, Huntsville, AL, 36816, US

(21) Appl. No.: 09/971,460

(22) Filed: Oct. 5, 2001

(51) Int. Cl. B62D 53/06

(52) U.S. Cl. 280/433; 280/400

(57) ABSTRACT

A truck tractor fifth wheel for semi-trailer trucks includes a built-in structure and mechanism for supporting and deploying a T-shaped retaining activation bar. The bar is carried underneath the fifth wheel and is supported on side walls of a support block cast integrally with the fifth wheel body. Upon being deployed in a jackknifing situation, an end of the bar comes into contact with a stop block underneath the trailer. Anti-jackknifing components are included in the fifth wheel design from the outset, thus avoiding difficulties associated with after-market installation of such components. Integral casting of components provides increased strength of the overall structure.

### FIELD OF THE INVENTION

This invention relates to apparatus for preventing jackknifing between tractors and connected trailers of semi tractor trucks.

### BACKGROUND OF INVENTION

A continuing problem arising in connection with operation of semi trailer trucks is the tendency of these vehicles to become jackknifed under certain conditions. Tractor and trailers are conventionally coupled together by a fifth wheel on the tractor in which a kingpin secured to the trailer is pivotally received. This coupling enables the tractor to pull the trailer and provides for relative pivotal movement for maneuvering the vehicle. Jackknifing occurs when the trailer pivots relative to the tractor to an extent such that the operator can no longer maintain or recover control over the vehicle. Typical driving conditions, which may cause jackknifing, are those in which the tractor wheels are made to lock and slide or to spin: in either case, the direction of the wheel can no longer be controlled, and it takes the path of least resistance. Improper braking or steering and accelerating or decelerating too fast can all cause jackknifes, especially on roads made slick by rain, snow, or ice. Anti-jackknifing arrangements have been developed to prevent or minimize jackknifing action by limiting the allowable pivotal movement between the tractor and trailer. Various anti-jackknifing devices for installation on trailer trucks are disclosed in prior patents. In general, these devices include a first stop retractably mounted on either the fifth wheel or on a wear plate under the trailer and a pair of cooperative stops mounted spaced apart on the other of these members. The pair of stops limits pivotal, movement beyond a predetermined angle when engaged by the first stop. These prior devices in general present a disadvantage in that they require cutting into the fifth wheel of the tractor and/or the wear plate of the trailer in order to provide necessary slots or recesses for operation of the movable stop members. This requirement makes installation of components on the fifth wheel and trailer difficult, and the resulting slots or recesses may substantially reduce the strength of the fifth wheel and trailer plate, in effect compromising the design and creating weak points susceptible to U.S. Pat. No. 4,991,863, issued Feb. 12, 1991 to the present applicant failure and which is hereby expressly incorporated by reference, largely avoids cutting into existing parts to provide slots or recesses but instead employs a framework of supporting gussets welded to the forward end of the fifth wheel and a forwardly extending plate outside the periphery of the fifth wheel. A latch block is pivotally mounted to the support frame and arranged for upward movement between gussets and into position to come into contact with stop blocks on the trailer. While this apparatus has been demonstrated to be effective, it has not found acceptance in the market place. Welding of a framework of gussets to the fifth wheel is considered enough of a change to cause concerns about an impact on pre-existing designs, as well as potential liability and insurance problems. In view of difficulties inherent in considering anti-jackknifing devices as being appropriate for treatment as “add-on” or after market equipment, applicant has concluded that a better approach is to provide an entirely new design in which anti-jackknife capability and components are included in the fifth wheel and trailer structure from the outset. This could overcome obstacles to acceptance as discussed above and would promote wider use to an important safety measure.

### SUMMARY OF THE INVENTION

The present invention is directed to an anti-jackknifing system operative to limit allowable pivoting motion between a fifth wheel mounted on a tractor and a trailer coupled to the fifth wheel by a kingpin. A T-shape retaining activation bar is carried at the forward end of the fifth wheel in position for being deployed above the plane of the fifth wheel so that ends of the bar will come into contact with stationary blocks placed on the underside of the trailer at prescribed angular locations. All necessary structure for supporting both the bar and for supporting all necessary components to bring about deployment are cast in place in the fifth wheel body, thus avoiding subsequent steps such as cutting slots in the fifth wheel or welding extensions or supporting gussets to it. As a result questions regarding integrity of the fifth wheel design upon adding anti-jackknifing capability will not be presented.

The fifth wheel of the present invention may have a generally circular shape at its forward end and a forked configuration at the rear to allow connection to a kingpin. Overall the fifth wheel has an inverted pan structure; with a flat upper contact surface and shallow sidewalls around its periphery perpendicular to the flat surface. To enable support for the retaining activation bar and components required for its deployment a support block including a mount is provided in a position spaced forward from the fifth wheel center and a pair of side support walls are placed for defining a pocket at the forward end of the fifth wheel. The side support walls have apertures for receiving a pivot pin, and the space between the walls is configured to allow necessary movement of the rear end of the bar. The location of this pivot pin is inside the circular periphery of the fifth wheel, thus allowing for shorter, more compact connecting rods and other components, in contrast to the prior arrangement where support was provided by an extension plate well forward of the fifth wheel periphery. Other features normally included in fifth wheels for purposes unrelated to prevention of jackknifing are also provided in the cast fifth wheel. In particular a pair of aperture tabs at both side walls for connection to pins that ride in bearings of support blocks attached to a tractor frame, a stabilizer bar connected to rear positions of forked legs of the fifth wheel and a slanted, thinner portion at ends of the legs to facilitate hook-up movement.

Inclusion of all features necessary to accommodate and support anti-jackknifing components in an integral cast fifth wheel at the outset enables these aspects to be given full consideration at an early design stage, in contrast to an “add-on” approach, which could compromise the integrity of the fifth wheel. Casting also provides better strength and wear properties than rolled plate metal. By placement of the pivot pin supporting the rear leg of the activation bar inside the periphery of the fifth wheel a shorter more stable mechanism is obtained.

It is therefore an object of this invention to provide an anti-jackknifing system using a cast fifth wheel including in the casting features for support of deployable components.

Another object is to provide such a system wherein a deployable retaining activation bar is located in a position such that pivoting of the bar around a pivot at its rearward end occurs within the forward periphery of a fifth wheel.

Another object is to provide a cast fifth wheel including as integral components thereof elements for support of a deployment mechanism.

Yet another object is to provide a more compact anti-jackknifing system having higher strength.

Other objects and advantages of the invention will be apparent from the following detailed description and the appended clams.

### BRIEF DISCRIPTIN OF THE DRAWINGS

FIG. 1 is a pictorial view of the fifth wheel embodying the invention installed on a frame of a truck trailer.

FIG. 2 is a partially diagrammatic view taken from below showing a restraining activation bar mounted underneath the fifth wheel of FIG. 1.

FIG. 3 is a pictorial view of structure for supporting the fifth wheel.

FIG. 4 is a sectional view of the fifth wheel taken along line 4-4 of FIG. 2.

FIG. 5 is a perspective view of a restraining activation bar as installed on the fifth wheel.

FIG. 6 is a perspective view of a pneumatic cylinder for deploying the bar of FIG. 2.

FIG. 7 is a side view, practically broken away showing deployment structure in place under the fifth wheel.

FIG. 8 is a perspective view taken from below, showing a kingpin and stop blocks installed under a tanker trailer.

FIG. 9 is an enlarged view showing details of stop blocks of FIG. 8.

### DESCRIPTION OF THE PREFERRED EMBODIMENT

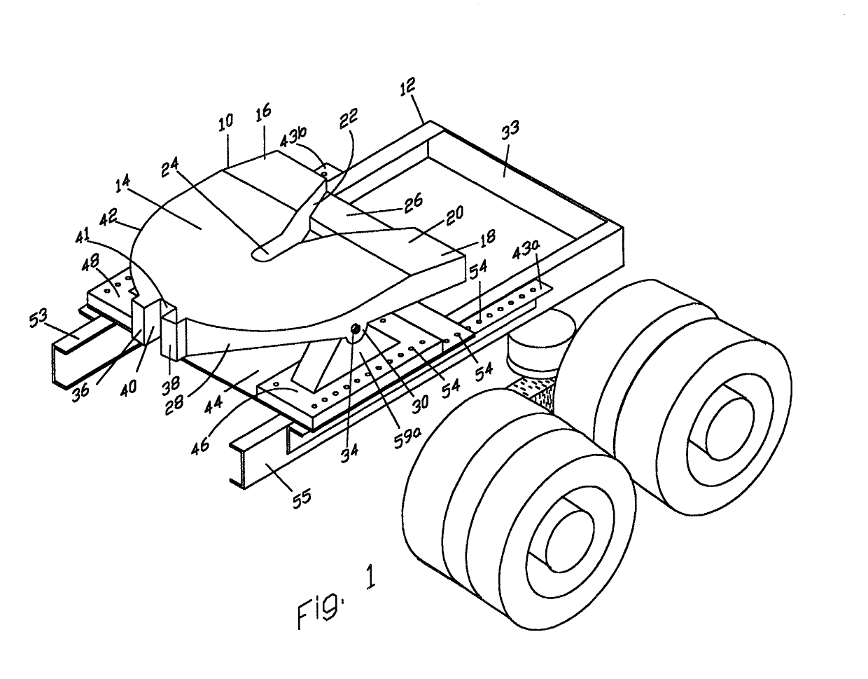

Referring to FIG. 1 of the drawings, there is shown a fifth wheel 10 mounted to a frame 12 of a tractor disposed for coupling with a trailer. The fifth wheel has front portion: 14 adapted to come into contact with a wear plate underneath the trailer body. Forked legs 16, 18 are provided at the rear of the fifth wheel. The legs have downwardly slanting rear portions 20 to facilitate making connecting with the trailer. A slot 22 is defined between the legs and terminates at a kingpin reception end 24. A stabilizer bar 26 extends across a lower portion of the slot to provide bracing. Side walls 28 perpendicular to flat surface 14 extend downward around the periphery of the fifth wheel.

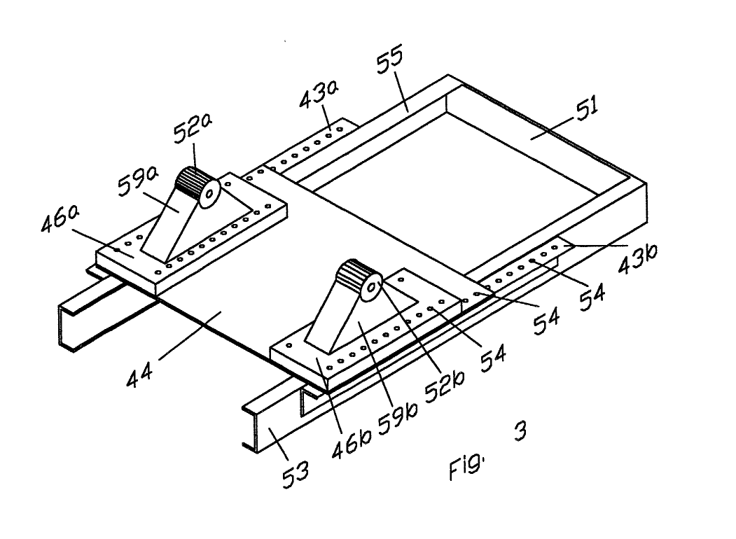

Mounting tabs 30,32 placed on opposite side walls 28 have an aperture for receiving a pivot pin 34 which connects the fifth wheel to a pair of bearings 52a, 52b (FIG. 3).

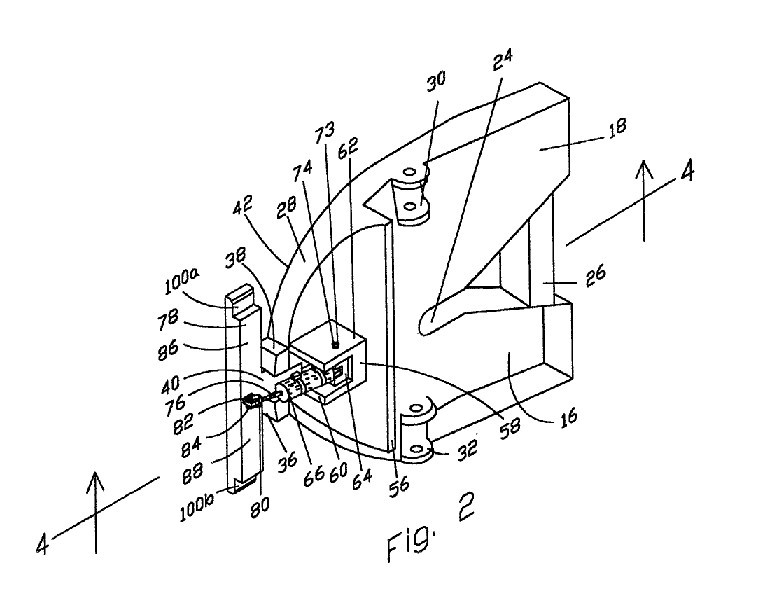

Spaced apart vertical stubs 36,38 having a generally rectangular cross section, are located at a center front edge of the fifth wheel, defining the outer portion of channel 40 for movement of a retaining activation bar (FIG. 2). An inner portion of this channel is formed by a slot 41 in the outer periphery 42 of front portion 14 of the fifth wheel.

Bearings 52a, 52b are supported on generally triangular mounting blocks 59a, 59b are carried on a supporting structure. Longitudinal side frame members 53,55 are connected along their length to angle steel bars 43a, 43b to provide more strength. A lower steel plate 44 extends across the width of the frame and is connected to angle steel bars on both sides. A pair of upper support plates 46a, 46b is placed on top of the lower plate at end locations. Mounting blocks 59a, 59b are secured on top of upper plates 46, 48. Bolts as shown by bolt holes 54 may used to make connection of the various plates.

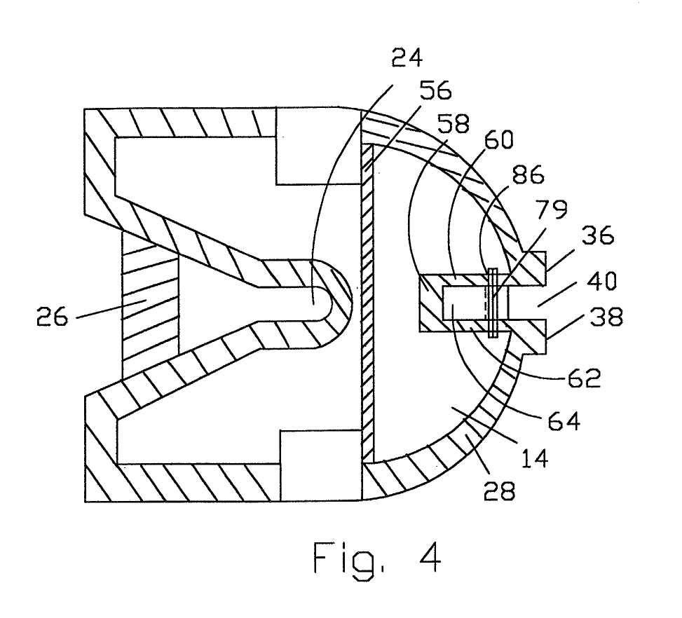

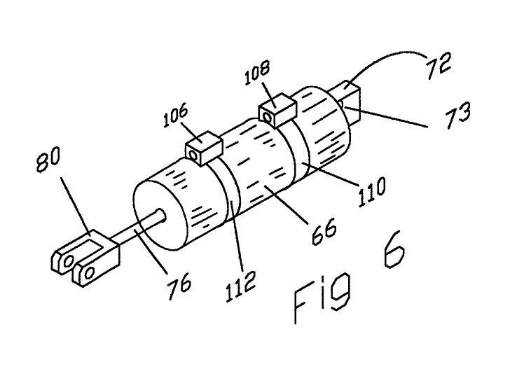

As Shown in FIG. 2 a T-shaped retaining activation bar 78 is supported under front portion 14 of fifth wheel 10 in a manner such as to facilitate deployment into position to come into contact with a stop block on the trailer when required. The fifth wheel has a supporting rib 56 across its width forward of slot end 24. A U-shaped support block 58 (FIG. 4) spaced apart forward to rib 56 has a pair of facing side walls 60, 62 in between which is located a mount 64. The mount has a pair of tabs 68, 70 that receive a lug 72 of air cylinder 66. (FIG. 6) An aperture 73 extends through the support block and the mount for placement of a pivot pin 74. Piston rod 76 propelled by the cylinder has a clevis 80 penetrated by aperture 83 at its outer end for engagement with lug 78, by means of pivot pin 84. Middle leg 90 of bar 78 is pivotally mounted on pivot pin 79 extending through side walls 60, 62 of support block 58, well within the outer perimeter of fifth wheel portion 14.

FIG. 4 shows support block 58 with downwardly extending walls 60, 62 cast integrally with vertical stubs 36, 38 forming a cavity or channel 40 for movement therein of tee 90 of bar 78 and the propelling air cylinder 66. This arrangement enables a more compact mechanism with highest strength.

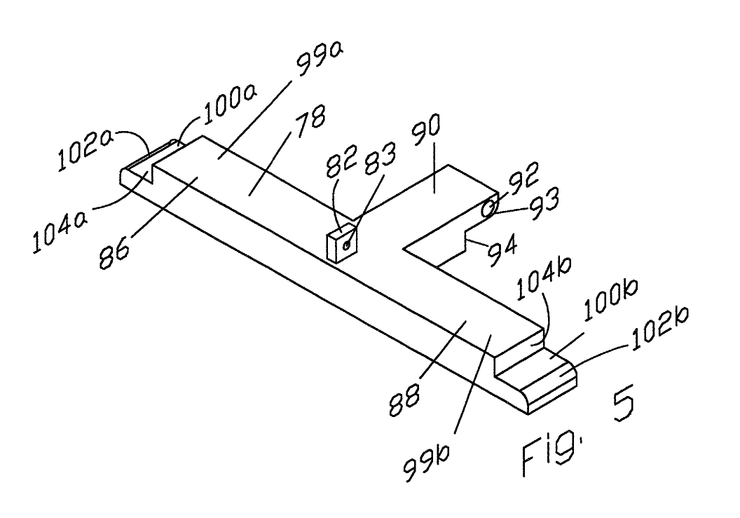

Details of retaining activation bar 78 are shown in FIG. 5, the bar in this view being in inverted position. The bar is T-shaped with a rectangular body portion made up of arms 86 and 88 and intersected by a mounting leg 90. At its outer end leg 90 has a corner notch 94 defined in its upper face to enable clearance around adjacent components during deployment and retraction. An aperture 92 parallel to the outer end of leg 90 enables passage of a pivot pin 79 connecting the bar to the fifth wheel. Lower edge 93 of the arm is rounded off to further facilitate movement of the bar. Ends 99a and 99b of arms 86 and 88 each have a corner notch 100a and 100b at their lower sides to provide for intermeshing with complementary features of stop blocks as will be explained below. Corner surfaces 102a and 102b are rounded off to enable smooth interlocking action. Contact surfaces 104a and 104b are arranged to come into flush contact with stop block surfaces when deployed. In its retracted position bar 78 is located below the plane of fifth wheel surface 14, and when deployed it moves upward into position wherever its upper surface becomes coplanar with the fifth wheel.

FIG. 6 shows an air cylinder 66 which may be used for deploying and retracting bar 78. The cylinder has a lug 72 at its inner end connected to mount 64 by means of pivot pin 74. A piston rod 76 extends from its outer end and has a clevis 80 for making connection with lug 82 located on the lower side of bar 78. The cylinder is powered by compressed air delivered from a source (not shown). Sensors 106, and 108 for measuring angular displacement may be located on the cylinder and held in place by bands 110 and 112.

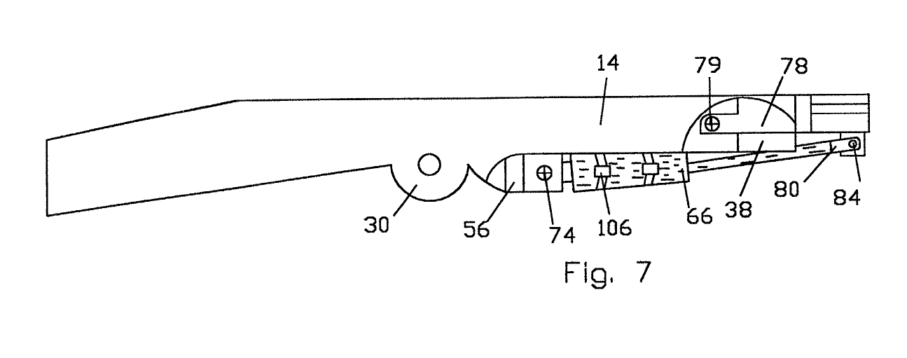

As shown in FIG. 7, restraining activation bar 78 moves upward into deployed position by action of air cylinder 66, causing pivoting around pin 79. This location is spaced inside the arcuate periphery of the fifth wheel, which coincides with the inner side of projecting stub 38.

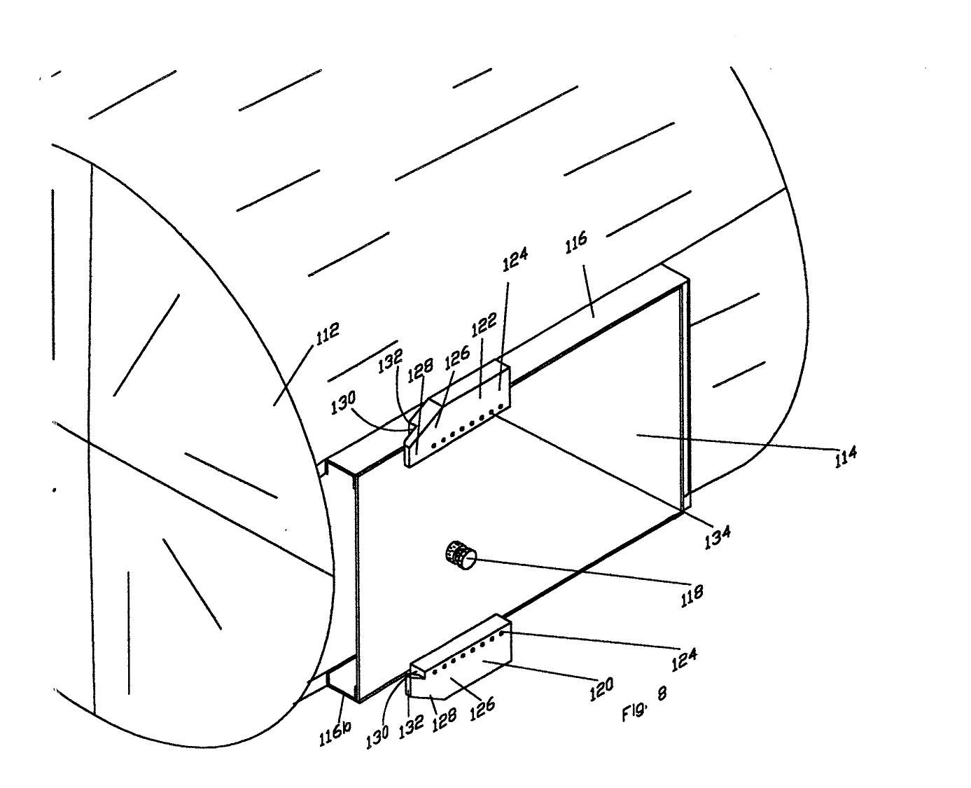

Placement of stop blocks on the underside of a trailer is shown in FIG. 8. In this embodiment the trailer 112 is a tanker trailer having a heavy plate positioned at the front end of the trailers, with a kingpin 118 mounted on the plate for engagement with a fifth wheel of a tractor. Side beams 116, 116b are used to connect the plates to the trailer. Stop blocks 120, 122 are connected to the plate at locations such that sides of the blocks will be contacted at surfaces 130 or 131 by a mating surface 104a or 104b of bar 78 when deployed and when the trailer undergoes pivotal movement beyond a predetermined angle.

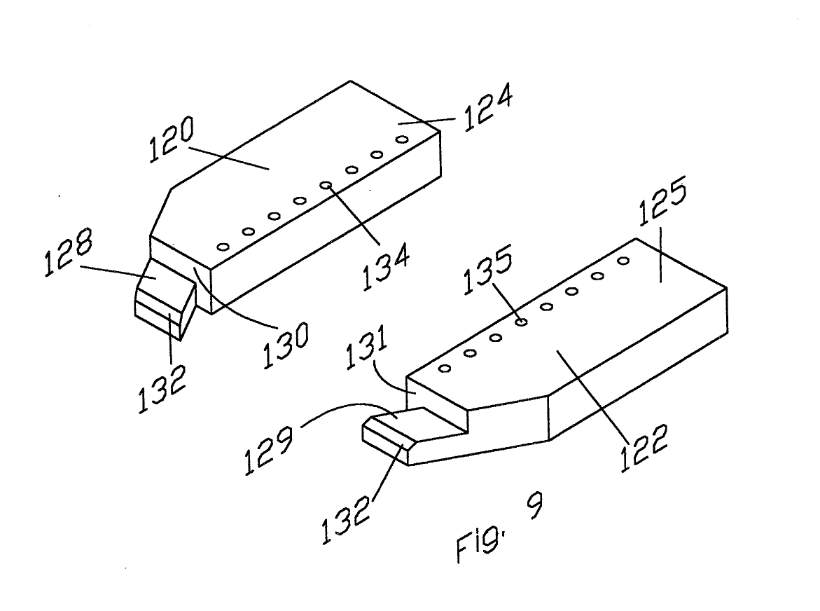

Stop blocks 120, 122 as shown in FIG. 9 have a generally rectangular body portion 124, 125 slanted inward to an inward corner at the forward end. A projecting end portion 128, 129 of one half the thickness of the block is provided at the bottom side of the block in order to intermesh with corner notches 100a and 100b so as to secure bar 78 from being sprung downward past a stop block upon occurrence of jackknifing. Corners indicated at 132 are preferably rounded off to facilitate deployment. Connection of the blocks to the wear plate may take the form of bolts (not shown) inserted in holes 134, 135. It is noted that blocks 120 and 122 are each designed for placement on a specific side of the trailer, here the blocks being mirror images of one another.

Components underneath the trailer are located and sized as follows blocks 120 and 122 are spaced 20 inches from the kingpin. The blocks each have a thickness of 3 inches, an overall length of 21 inches and a width of 7 inches. Projecting end portions 128, 129 have a thickness of 2 inches and a width of 4 inches. The blocks are installed parallel to sides of plate 114, and contacting surfaces of ends of the blocks have an angle of 36 degrees with respect to the center line of the kingpin so as to come into flush contact with the bar upon deployment.

The system described above may be controlled by use of sensors, switching devices and electronic components as described in applicant's prior patent, referenced above. In particular, deployment and retraction of the retaining activation bar, carried out by turning the compressed air supply off and on, may be coupled to a speed-responsive signal generator so that the air may be turned on and off at predetermined speeds. This feature, for disabling of the system at a selected low speed such as 15 miles per hour is provided to enable the truck to make sharp turns when needed as in certain city traffic. In addition the control system may include a memory device which records time and date information in conjunction with deployment and retraction of bar, this providing an accurate record of jackknifing events.

While the invention is described above in terms of specific embodiments, it is not to be understood as limited thereto but is limited only as indicated by the following clams.

1. A fifth wheel attachable to framework of a truck tractor and adapted for being coupled to a trailer having a wear plate disposed underneath said trailer and carrying a downward projecting kingpin, said fifth wheel comprising a flat, generally semicircular forward plate portion and an axially located kingpin respectable.
A pair of spaced a part side walls extending downward per perpendicularly from said forward plate portion and defining there between a cavity for receiving a deployable anti-jackknifing bar; and
A pivot pin supported by said walls and pivotally connected to a said bar at an axis perpendicular to said bar and located inside an arcuate periphery of said forward plate portion.

2. A fifth wheel assembly comprising a cast steel fifth wheel having a flat, generally semicircular plate portion, a bifurcated rear portion and a kingpin receptacle disposed at a central location of said semicircular plate portion;
A pair of spaced apart walls cast integrally with said plate portion, said walls perpendicular to said plate and defining a forward-extending cavity between said walls:
A t-shaped retention activation bar having a linear portion with stop-block contacting surfaces provided at both ends thereof and a leg perpendicular to said linear portion, said leg at an outer end thereof including a transverse aperture; and
A pivot pin carried by said walls and disposed in said aperture to enable pivotal movement of said bar.
